(19) United States
(12) Patent Application Publication
(10) Pub. No.: US 2026/0200267 A1
(43) Pub. Date: Jul. 16, 2026

(54) DRIVER AXLE, MODEL VEHICLE, AND UNMANNED VEHICLE

(71) Applicant: Zhuhai Edge Smart Drive Technology Co., Ltd, Zhuhai (CN)

(72) Inventors: Gongcai JIN, Zhuhai (CN); Gonghua JIN, Zhuhai (CN); Xiang REN, Zhuhai (CN)

(21) Appl. No.: 19/198,907

(22) Filed: May 5, 2025

(30) Foreign Application Priority Data
Jan. 15, 2025 (CN) 202510061010.4

(51) Int. Cl. B60B 35/18; A63H 17/00; B60K 1/00; B60K 17/04

(52) U.S. Cl. CPC B60B 35/18; A63H 17/00; B60K 1/00; B60K 17/043; B60K 2001/001

(57) ABSTRACT

A driving axle, a model vehicle, and an unmanned vehicle are disclosed. The driving axle includes a motor provided with two output power shafts arranged on both ends respectively, where the two output power shafts are configured to output synchronous output power; two couplings, where an end of the two couplings is connected to the two output power shafts respectively; two transmission axles, where each of the two transmission axles includes a respective housing of two housings and a respective one of two transmission shafts, each of the two transmission shafts is arranged in the respective housing, and an end of each of the two transmission shafts is connected to the other end of a respective one of the two couplings; and two wheels, where an end of each of the two wheels is connected to the other end of a respective transmission shaft of the two transmission shafts.

### TECHNICAL FIELD

The present disclosure relates to the technical field of power driving, and in particular, to a driving axle, a model vehicle, and an unmanned vehicle.

### BACKGROUND

The power transmission of existing model vehicles and unmanned vehicles usually uses a complex transmission device to transmit the power of the power equipment to the wheels through a speed reducer and differential distribution. The model vehicles and unmanned vehicles are used outdoors and in other non-paved environments. Compared with passenger vehicles, the model vehicles and unmanned vehicles have very high power reserves. Therefore, from the perspective of the use environment and power reserve of the model vehicles and unmanned vehicles, the wheels of the model vehicles and unmanned vehicles are often in a condition that the wheels skid as the wheels break through the grip. Therefore, if the powered wheels of the model vehicles and unmanned vehicles use differential drive, the tires will easily skid and cause power loss, making it difficult for the vehicle to escape from trouble. Most of the existing model vehicles and unmanned vehicles retain traditional transmission devices such as a speed reducer and a differential, which makes the transmission system more complicated, difficult to maintain, and noisy during driving. Therefore, the technical problem that needs to be solved urgently is how to simplify the transmission structure and reduce the power loss.

### SUMMARY

An objective of the present disclosure is to solve at least one of the technical problems existing in the existing technologies. To this end, the present disclosure provides a driving axle, a model vehicle, and an unmanned vehicle, which simplifies the structure of a transmission device and reduce the power loss.

In order to achieve the above objective, the present disclosure adopts the following technical scheme.

In a first aspect, the present disclosure provides a driving axle, which includes:
a motor, where the motor is provided with two output power shafts arranged on both ends respectively, and the two output power shafts are configured to output synchronous output power;
two couplings, where an end of each of the two couplings is connected to a respective output power shaft of the two output power shafts;
two transmission axles, where each of the two transmission axles includes a respective housing of two housings and a respective transmission shaft of two transmission shafts, each of the two transmission shafts is arranged in the respective housing, and an end of each of the two transmission shafts is connected to the other end of a respective one of the two couplings; and
two wheels, where an end of each of the two wheels is connected to the other end of a respective transmission shaft of the two transmission shafts..

According to the embodiment in the first aspect of the present disclosure, the driving axle has at least the following beneficial effects. By arranging the output power shaft at both ends of the motor, power can be outputted synchronously. Each of the two couplings are connected between the output power shaft and the transmission axle, and the transmission axle includes a housing and a transmission shaft arranged therein. The power is further transmitted to the wheels connected thereto through the drive shaft, achieving efficient power output. Compared with the existing technologies, the driving axle in the embodiment of the present disclosure outputs power synchronously through both ends of the motor and directly drives the wheels through the couplings and the transmission axles, which simplifies the complex structure of the traditional transmission device, reduces the power loss, and significantly improves the transmission efficiency. Moreover, the simplified power transmission path reduces the number of vulnerable parts, facilitates subsequent maintenance, and prolongs the service life. Therefore, the embodiments of the present disclosure solve the technical problem of simplifying the structure of the transmission device and reducing the power loss.

According to some embodiments in the first aspect of the present disclosure, each of the two transmission axles further includes two bearings, where the two bearings are arranged at both ends of the respective transmission shaft respectively, and the two bearings are configured to cause the respective housing and the respective transmission shaft to be fixedly connected.

According to some embodiments in the first aspect of the present disclosure, a threaded hole is formed at both ends of the motor, a first through hole matching the threaded hole is formed at an end of each of the two housings close to the respective output power shaft, and the threaded hole and the first through hole are configured for a screw to pass through, such that the motor and the two housings are fixedly connected.

According to some embodiments in the first aspect of the present disclosure, each of the two housings includes a respective tapered sleeve of two tapered sleeves and a respective straight sleeve of two straight sleeves, a large end of each of the two tapered sleeves conforms to an end part of the motor, a small end of each of the two tapered sleeves is connected to an end of a respective one of the two straight sleeves, and for each of the two housings, the other end of the respective transmission shaft stretches out from the other end of the respective straight sleeve.

According to some embodiments in the first aspect of the present disclosure, a fixing groove is formed at the large end of each of the two tapered sleeves, and a sealing block is arranged in the fixing groove.

According to some embodiments in the first aspect of the present disclosure, a connecting plate is arranged between an outer wall of each of the two tapered sleeves and an outer wall of the respective straight sleeve.

According to some embodiments in the first aspect of the present disclosure, an end part of each of the two output power shafts is in a flat shape, and the shape of a connector at an end of each of the two couplings conforms to the shape of the end part of the respective output power shaft.

According to some embodiments in the first aspect of the present disclosure, a second through hole is formed at an end of each of the two wheels proximate to the respective transmission shaft, an external threaded shaft and a hexagonal column are arranged at an end of each of the two transmission shafts proximate to the respective wheel, the hexagonal column for each of the two transmission shafts is capable of being embedded into the second through hole of the respective wheel, the external threaded shaft is integrally connected to the hexagonal column for each of the two transmission shafts, and the external threaded shaft for each of the two transmission shafts is configured to pass through the second through hole of the respective wheel and a respective external fastener in sequence, such that the two wheels and their respective transmission shafts are fixedly connected.

In a second aspect, the present disclosure provides a model vehicle, which includes the driving axle described in the embodiments in the first aspect of the present disclosure.

In a third aspect, the present disclosure provides an unmanned vehicle which includes the driving axle described in the embodiments in the first aspect of the present disclosure.

The present disclosure is further described below in conjunction with the accompanying drawings and embodiments.

### BRIEF DESCRIPTION OF DRAWINGS

FIG. 1 is a schematic structural diagram of an embodiment of a driving axle of the present disclosure;

FIG. 2 is an exploded schematic diagram of an embodiment of a driving axle of the present disclosure; and

FIG. 3 is a cross-sectional view of an embodiment of the driving axle of the present disclosure.

Reference numerals:
motor 100, output power shaft 110, threaded hole 120,
coupling 200,
transmission axle 300, housing 310, first through hole 311, tapered sleeve 312, fixing groove 313, straight sleeve 314, connecting plate 315, transmission shaft 320, external threaded shaft 321, hexagonal column 322, bearing 330,
wheel 400, second through hole 410.

### DETAILED DESCRIPTION

Embodiments of the present disclosure are described in detail below, and examples of the embodiments are shown in the accompanying drawings, where the same or similar reference numerals throughout represent the same or similar elements or elements having the same or similar functions. The embodiments described below with reference to the accompanying drawings are illustrative and are only used to explain the present disclosure, and should not be construed as limiting the present disclosure.

In the description of the present disclosure, it should be understood that in the descriptions involving orientation, the orientation or positional relationship indicated by orientations such as up, down, front, back, left, and right is based on the orientation or positional relationship shown in the accompanying drawings, and is only for the convenience of describing the present disclosure and simplifying the description, rather than indicating or implying that the device or element referred to must have a specific orientation, be constructed and operated in a specific orientation, and therefore should not be understood as a limitation on the present disclosure.

In the description of the present disclosure, the meaning of “several” refers to one or more, and the meaning of “a plurality of (or multiple)” refers to two or more. The terms such as “greater than”, “less than”, “over” are understood not to include the specified number, while the terms such as “above”, “below”, “within” are understood to include the specified number. If described, the words such as “first”, “second” are merely for the purpose of distinguishing technical features, and not to be construed as indicating or implying relative importance or implicitly indicating the number of technical features indicated or implicitly indicating the precedence relationship of technical features indicated.

In the description of the present disclosure, unless otherwise specifically defined, the terms such as arranging, mounting, connecting, etc. should be understood in a broad sense, and those skilled in the art can reasonably determine the specific meanings of the above terms in conjunction with the specific content of the technical scheme in the present disclosure.

The embodiments of the present disclosure are further described below in conjunction with the accompanying drawings.

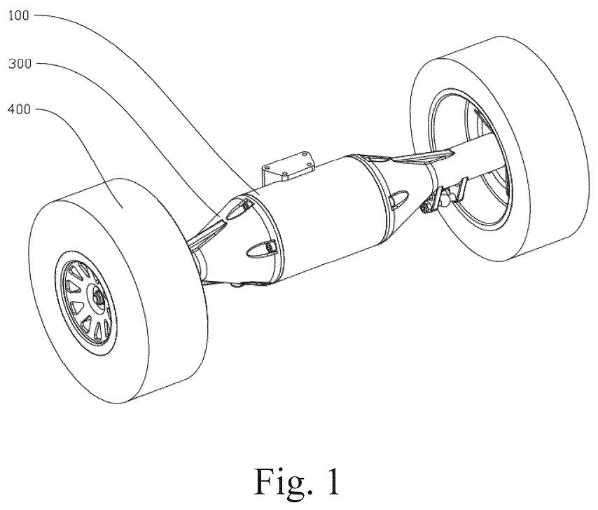

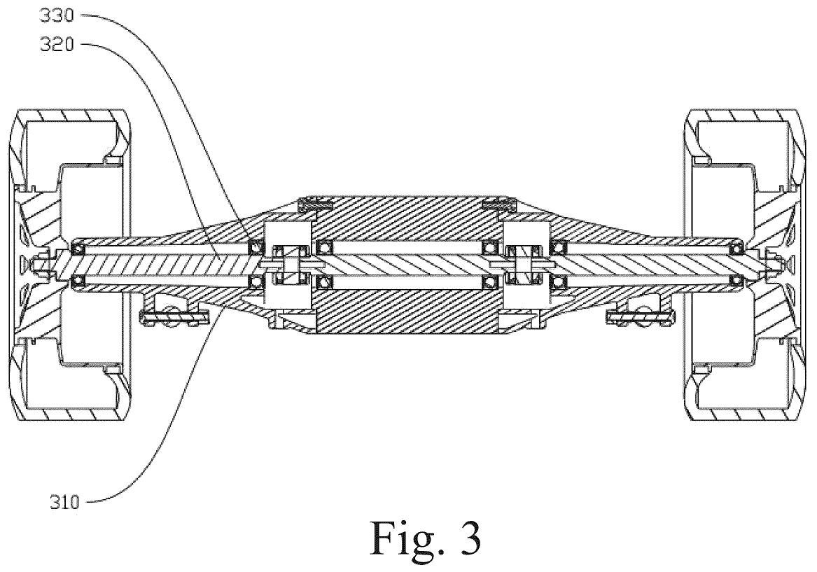

Referring to FIGS. 1, 2, and 3, a driving axle includes a motor 100, couplings 200, transmission axles 300, and wheels 400. Each of both ends of the motor 100 is provided with an output power shaft 110, and the two output power shafts 110 are configured to output synchronous output power; the couplings 200 are arranged in two, where an end of each of the two couplings 200 is connected to a respective one of the two output power shafts 110; two transmission axles 300 are arranged, where each of the two transmission axles 300 includes a housing 310 and a transmission shaft 320. The transmission shaft 320 is arranged in the housing 310, and an end of each of the two transmission shafts 320 is connected to the other end of a respective coupling 200; and two wheels 400 are arranged, where an end of each of the two wheels 400 is connected to the other end of a respective transmission shaft 320.

In the above embodiment, an output power shaft 110 is arranged at both ends of the motor 100, such that the power can be outputted synchronously. Each of the two couplings 200 is connected between the respective output power shaft 110 and the respective transmission axle 300. Each of the transmission axles 300 includes a housing 310 and a transmission shaft 320 arranged therein. The power is in turn transmitted to the wheels 400 connected thereto through the transmission shaft 320, thereby achieving efficient power output. Compared with the existing technologies, the driving axle of the embodiment of the present disclosure outputs power synchronously through both ends of the motor 100, and directly drives the wheels 400 through the couplings 200 and the transmission axles 300, which simplifies the complex structure of the traditional transmission device, reduces the power loss, and significantly improves the transmission efficiency. Moreover, the simplified power transmission path reduces the number of vulnerable parts, facilitates subsequent maintenance, and prolongs the service life.

It is understandable that, referring to FIGS. 1, 2 and 3, each of the transmission axles 300 further includes two bearings 330, where the two bearings 330 are arranged at both ends of the transmission shaft 320 respectively. The bearings 330 are configured to cause the housings 310 and the transmission shafts 320 to be fixedly connected. The bearings 330 are arranged to fixedly connect the housings 310 and the transmission shafts 320 without affecting the transmission shafts 320 transmitting power to the wheels 400.

As shown in FIGS. 1, 2, and 3, the two transmission axles 300 and four bearings 330 are arranged as an example. In one transmission axle 300, a bearing 330 is arranged at a connection between the transmission axle 300 and the output power shaft 110, and another bearing 330 is arranged at a connection between the transmission axle 300 and the wheel 400. The same is true for the other transmission axle 300. The motor 100 drives the transmission shaft 320 to rotate and transmit power to the wheels 400 to rotate the wheels 400. The bearings 330 can fixedly connect the housings 310 and the transmission shafts 320 without affecting the transmission shafts 320 transmitting power.

It should be appreciated that, referring to FIGS. 1, 2, and 3, a threaded hole 120 is formed at both ends of the motor 100, and a first through hole 311 matching the threaded holes is formed at an end of the housing 310 close to the output power shaft 110, and the threaded holes 120 and the first through hole 311 are configured for screws to pass through, such that the motor 100 and the housing 310 are fixedly connected.

The embodiment of the present disclosure does not limit the numbers of the threaded holes 120 and first through holes 311, and those skilled in the art can adjust the numbers according to actual conditions. The number of the threaded holes 120 matches the number of the first through holes 311. In some examples, as shown in FIGS. 1, 2, and 3, ten threaded holes 120 and ten first through holes 311 are formed as an example. Five threaded holes 120 are formed evenly at a side where the output power shaft 110 of the motor 100 is located, and another five threaded holes 120 are formed evenly at the other side where the other output power shaft 110 of the motor 100 is located. Five first through holes 311 are formed at a side of the housing 310 of a specific one transmission axle 300 facing the motor 100, and another five first through holes 311 are formed at a side of the housing 310 of another transmission axle 300 facing the motor 100. The positions of the threaded holes 120 and the first through holes 311 correspond to one another. External screws can pass through the first through holes 311 and the threaded holes 120 in sequence to fixedly connect the housings 310 of the two transmission axles 300 and the motor 100.

It should be appreciated that, referring to FIGS. 1, 2, and 3, the housing 310 includes a tapered sleeve 312 and a straight sleeve 314, a large end of the tapered sleeve 312 conforms to an end part of the motor 100, a small end of the tapered sleeve 312 is connected to an end of the straight sleeve 314, and the other end of the drive shaft 320 other than the end thereof connected to the coupling 200 stretches out from the other end of the straight sleeve 314. By arranging the housing 310 to include the tapered sleeve 312 and the straight sleeve 314, the volume of the housing 310 can be reduced, making the housing 310 lighter, thereby reducing the load on the driving axle and increasing the transmission efficiency of the motor 100.

In some embodiments, as shown in FIGS. 1, 2, and 3, the tapered sleeve 312 and the straight sleeve 314 are integrally formed. The large end of the tapered sleeve 312 conforms to a side surface of the motor 100, and can better fit the motor 100, such that the connection between the housing 310 and the motor 100 is more stable. The cross-sectional area of the straight sleeve 314 matches the transmission shaft 320, which can better protect the transmission shaft 320. Moreover, the housing is smaller and lighter, such that the volume and weight of the entire housing 310 are reduced, the load on the driving axle is reduced, and the transmission efficiency of the motor 100 is improved.

It is understandable that, referring to FIGS. 1, 2, and 3, a fixing groove 313 is formed at the large end of the tapered sleeve 312, and a sealing block is arranged in the fixing groove 313. By arranging the fixing groove 313 at the large end of the tapered sleeve 312, the weight of the tapered sleeve 312 can be reduced, and the sealing block can make the motor 100 and the housing 310 more sealed after connection, thereby reducing the probability of requiring maintenance later.

The embodiment of the present disclosure does not limit the numbers of the fixing grooves 313 and sealing blocks, and those skilled in the art may adjust the numbers according to actual conditions. The number of the fixing grooves 313 matches the number of the sealing blocks. In some embodiments, as shown in FIGS. 1, 2, and 3, a housing 310 is provided with five fixing grooves 313 and five sealing blocks as an example. In one housing 310, the five fixing grooves 313 and the five first through holes 311 are arranged alternately, and the five sealing blocks are respectively arranged in the five fixing grooves 313.

It can be understandable that, as shown in FIGS. 1, 2, and 3, a connecting plate 315 is arranged between an outer wall of the tapered sleeve 312 and an outer wall of the straight sleeve 314. By arranging the connecting plate 315 between the outer wall of the tapered sleeve 312 and the outer wall of the straight sleeve 314, the structures of the tapered sleeve 312 and the straight sleeve 314 are more stable, the probability that the tapered sleeve 312 is separated from the straight sleeve 314 due to force damage is reduced, and the service life is prolonged.

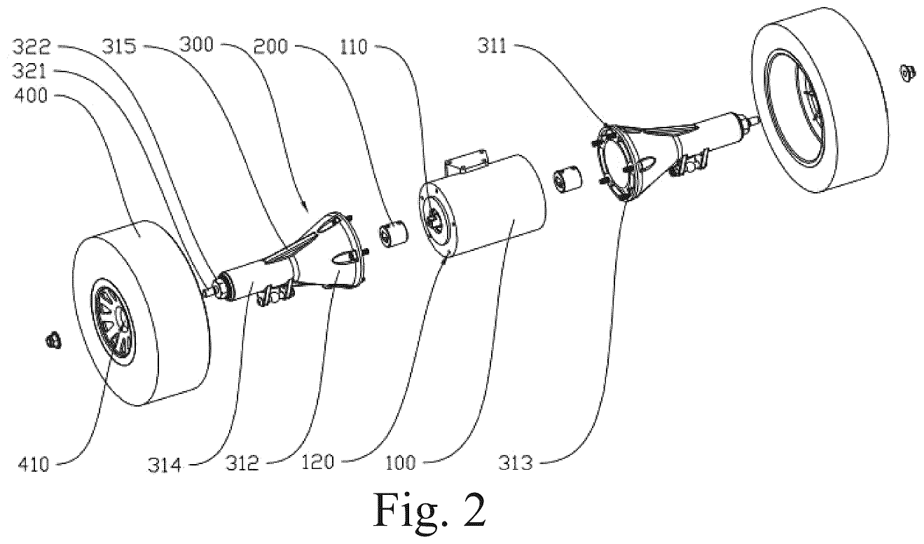

The embodiment of the present disclosure does not limit the number of the connecting plates, and those skilled in the art can adjust the number according to actual conditions. As shown in FIG. 2, one connecting plate 315 is arranged between one tapered sleeve 312 and one straight sleeve 314 as an example. The connecting plate 315 is integrally formed with the tapered sleeve 312 and the straight sleeve 314. One end of the connecting plate 315 is connected to an outer wall of the small end of the tapered sleeve 312, and the other end of the connecting plate 315 is connected to an outer wall of one end of the straight sleeve 314 facing the tapered sleeve 312. The connection plate 315 can reduce the stress at the connection between the tapered sleeve 312 and the straight sleeve 314, and reduce the probability that the tapered sleeve 312 is separated from the straight sleeve 314 caused by damage to the connection between the tapered sleeve 312 and the straight sleeve 314.

It should be appreciated that, referring to FIGS. 1, 2, and 3, an end of the output power shaft 110 is in a flat shape, and the shape of a connector at an end of the coupling 200 conforms to the shape of the end part of the output power shaft 110, such that the connection between the coupling 200 and the output power shaft 110 is more stable, reducing the probability that the output power shaft 110 is separated from the transmission shaft 320.

It should be appreciated that, referring to FIGS. 1, 2, and 3, a second through hole 410 is formed at one end of the wheel 400 proximate to the transmission shaft 320, and an external threaded shaft 321 and a hexagonal column 322 are arranged at one end of the transmission shaft 320 proximate to the wheels 400. The hexagonal column 322 can be embedded into the second through hole 410, and the external threaded shaft 321 is integrally connected with the hexagonal column 322. The external threaded shaft 321 is configured to pass through the second through hole 410 and an external fastener in sequence, such that the wheel 400 and the transmission shaft 320 are fixedly connected, thereby reducing the probability that the wheel 400 is separated from the transmission shaft 320.

The driving axle in the first embodiment of the present disclosure makes the model vehicle in the second embodiment of the present disclosure lighter and more powerful.

In some embodiments, the model vehicle can be a remote control racing vehicle. The driving axle is lightweight in design and highly efficient in driving, such that the model vehicle can reach a higher speed within a shorter time, thereby improving the competitiveness in the competition. In addition, the driving axle can also provide a stable power output, ensuring that the remote control racing vehicle has better controllability when driving at high speeds, reducing the phenomenon of loss of control due to uneven power transmission. The model vehicle can also be an entertainment model vehicle, and the application of the driving axle can also improve the experience of the entertainment model vehicle. For example, on a rough terrain, the entertainment model vehicle can overcome higher slopes and obstacles with the optimized design of the driving axle, bringing smoother driving experience and increasing the durability and adaptability of the entertainment model vehicle.

The driving axle in the first aspect embodiment of the present disclosure enables the unmanned vehicle in the third aspect embodiment of the present disclosure to be lighter, more powerful, better adaptable to different work scenarios, and further improves the work efficiency.

In some embodiments, in disaster or emergency rescue scenarios, the driving axle can enable the unmanned vehicle to have a stronger power output and higher passability, ensuring that the unmanned vehicle can travel quickly in complex terrains or dangerous environments. For example, in mountainous disaster areas or places where roads are blocked, a driving axle-optimized drive system can provide stable power, allowing the unmanned vehicle to traverse obstacles and transport necessitous supplies. In some large construction sites, warehouses or logistics transportation scenarios, the driving axle enables the unmanned vehicle to carry more cargos while having stronger power. During the transportation process, whether the vehicle is crossing relatively flat grounds or irregular roads, the driving axle can ensure the efficient and stable operation of the unmanned vehicle, thereby improving the transportation efficiency and reducing human intervention. In security monitoring and patrol missions, the design of the driving axle can enhance the flexibility and maneuverability of the unmanned vehicle in the complex terrain. For example, the unmanned vehicle patrolling cities or industrial areas needs to respond quickly in different environments. The optimized design of the driving axle allows the unmanned vehicle to navigate freely on complex streets, ramps and even muddy roads, detect abnormal situations in a timely manner and provide feedback on monitoring data. The driving axle can also dynamically adjust power output through integrated sensors and intelligent control systems, allowing the unmanned vehicle to automatically adapt to different loads and ground conditions according to changes in the working environment. For example, in deserts or snow-covered areas, the driving axle can automatically adjust the output power according to the ground friction, ensuring that the unmanned vehicle always maintains optimal traction and driving stability.

The embodiments of the present disclosure are described in detail above in conjunction with the accompanying drawings, but the present disclosure is not limited to the above embodiments. Various changes can be made within the knowledge scope of those of ordinary skill in the art without departing from the gist of the present disclosure.

What is claimed is:

1. A driving axle, comprising:
a motor, wherein the motor is provided with two output power shafts arranged on both ends respectively, and the two output power shafts are configured to output synchronous output power;
two couplings, wherein an end of each of the two couplings is connected to a respective output power shaft of the two output power shafts;
two transmission axles, wherein each of the two transmission axles comprises a respective housing of two housings and a respective transmission shaft of two transmission shafts, each of the two transmission shafts is arranged in the respective housing, and an end of each of the two transmission shafts is connected to the other end of a respective one of the two couplings; and
two wheels, wherein an end of each of the two wheels is connected to the other end of a respective transmission shaft of the two transmission shafts.

2. The driving axle according to claim 1, wherein each of the two transmission axles further comprises two bearings, the two bearings are arranged at both ends of the respective transmission shaft respectively, and the two bearings are configured to cause the respective housing and the respective transmission shaft to be fixedly connected.

3. The driving axle according to claim 1, wherein a threaded hole is formed at both ends of the motor, a first through hole matching the threaded hole is formed at an end of each of the two housings close to the respective output power shaft, and the threaded hole and the first through hole are configured for a screw to pass through, such that the motor and the two housings are fixedly connected.

4. The driving axle according to claim 1, wherein each of the two housings comprises a respective tapered sleeve of two tapered sleeves and a respective straight sleeve of two straight sleeves, a large end of each of the two tapered sleeves conforms to an end part of the motor, a small end of each of the two tapered sleeves is connected to an end of a respective one of the two straight sleeves, and for each of the two housings, the other end of the respective transmission shafts stretches out from the other end of the respective straight sleeve.

5. The driving axle according to claim 4, wherein a fixing groove is formed at the large end of each of the two tapered sleeves, and a sealing block is arranged in the fixing groove.

6. The driving axle according to claim 4, wherein a connecting plate is arranged between an outer wall of each of the two tapered sleeves and an outer wall of the respective straight sleeve.

7. The driving axle according to claim 1, wherein an end part of each of the two output power shafts is in a flat shape, and the shape of a connector at an end of each of the two couplings conforms to the shape of the end part of the respective output power shaft.

8. The driving axle according to claim 1, wherein a second through hole is formed at an end of each of the two wheels proximate to the respective transmission shaft, an external threaded shaft and a hexagonal column are arranged at an end of each of the two transmission shafts proximate to the respective wheel, the hexagonal column for each of the two transmission shafts is capable of being embedded into the second through hole of the respective wheel, the external threaded shaft is integrally connected to the hexagonal column for each of the two transmission shafts, and the external threaded shaft for each of the two transmission shafts is configured to pass through the second through hole of the respective wheel and a respective external fastener in sequence, such that the two wheels and their respective transmission shafts are fixedly connected.

9. A model vehicle, comprising a driving axle, wherein the driving axle comprises:
a motor, wherein the motor is provided with two output power shafts arranged on both ends respectively, and the two output power shafts are configured to output synchronous output power;
two couplings, wherein an end of each of the two couplings is connected to a respective output power shaft of the two output power shafts;
two transmission axles, wherein each of the two transmission axles comprises a respective housing of two housings and a respective transmission shaft of two transmission shafts, each of the two transmission shafts is arranged in the respective housing, and an end of each of the two transmission shafts is connected to the other end of a respective one of the two couplings; and
two wheels, wherein an end of each of the two wheels is connected to the other end of a respective transmission shaft of the two transmission shafts.

10. The model vehicle according to claim 9, wherein each of the two transmission axles further comprises two bearings, the two bearings are arranged at both ends of the respective transmission shaft respectively, and the two bearings are configured to cause the respective housing and the respective transmission shaft to be fixedly connected.

11. The model vehicle according to claim 9, wherein a threaded hole is formed at both ends of the motor, a first through hole matching the threaded hole is formed at an end of each of the two housings close to the respective output power shaft, and the threaded hole and the first through hole are configured for a screw to pass through, such that the motor and the two housings are fixedly connected.

12. The model vehicle according to claim 9, wherein each of the two housings comprises a respective tapered sleeve of two tapered sleeves and a respective straight sleeve of two straight sleeves, a large end of each of the two tapered sleeves conforms to an end part of the motor, a small end of each of the two tapered sleeves is connected to an end of a respective one of the two straight sleeves, and for each of the two housings, the other end of the respective transmission shafts stretches out from the other end of the respective straight sleeve.

13. The model vehicle according to claim 12, wherein a fixing groove is formed at the large end of each of the two tapered sleeves, and a sealing block is arranged in the fixing groove.

14. The model vehicle according to claim 12, wherein a connecting plate is arranged between an outer wall of each of the two tapered sleeves and an outer wall of the respective straight sleeve.

15. The model vehicle according to claim 9, wherein an end part of each of the two output power shafts is in a flat shape, and the shape of a connector at an end of each of the two couplings conforms to the shape of the end part of the respective output power shaft.

16. The model vehicle according to claim 9, wherein a second through hole is formed at an end of each of the two wheels proximate to the respective transmission shaft, an external threaded shaft and a hexagonal column are arranged at an end of each of the two transmission shafts proximate to the respective wheel, the hexagonal column for each of the two transmission shafts is capable of being embedded into the second through hole of the respective wheel, the external threaded shaft is integrally connected to the hexagonal column for each of the two transmission shafts, and the external threaded shaft for each of the two transmission shafts is configured to pass through the second through hole of the respective wheel and a respective external fastener in sequence, such that the two wheels and their respective transmission shafts are fixedly connected.

17. An unmanned vehicle, comprising a driving axle, wherein the driving axle comprises:
a motor, wherein the motor is provided with two output power shafts arranged on both ends respectively, and the two output power shafts are configured to output synchronous output power;
two couplings, wherein an end of each of the two couplings is connected to a respective output power shaft of the two output power shafts;
two transmission axles, wherein each of the two transmission axles comprises a respective housing of two housings and a respective transmission shaft of two transmission shafts, each of the two transmission shafts is arranged in the respective housing, and an end of each of the two transmission shafts is connected to the other end of a respective one of the two couplings; and
two wheels, wherein an end of each of the two wheels is connected to the other end of a respective transmission shaft of the two transmission shafts.

18. The unmanned vehicle according to claim 17, wherein each of the two transmission axles further comprises two bearings, the two bearings are arranged at both ends of the respective transmission shaft respectively, and the two bearings are configured to cause the respective housing and the respective transmission shaft to be fixedly connected.

19. The unmanned vehicle according to claim 17, wherein a threaded hole is formed at both ends of the motor, a first through hole matching the threaded hole is formed at an end of each of the two housings close to the respective output power shaft, and the threaded hole and the first through hole are configured for a screw to pass through, such that the motor and the two housings are fixedly connected.

20. The unmanned vehicle according to claim 17, wherein each of the two housings comprises a respective tapered sleeve of two tapered sleeves and a respective straight sleeve of two straight sleeves, a large end of each of the two tapered sleeves conforms to an end part of the motor, a small end of each of the two tapered sleeves is connected to an end of a respective one of the two straight sleeves, and for each of the two housings, the other end of the respective transmission shafts stretches out from the other end of the respective straight sleeve.
